(19) United States
(12) Patent Application Publication
(10) Pub. No.: US 2007/0001512 A1
(43) Pub. Date: Jan. 4, 2007

(54) Image sending apparatus

(75) Inventors: Masayuki Sato, Utsunomiya-shi (JP); Takeyuki Suzuki, Utsunomiya-shi (JP)

Correspondence Address: DITTHAVONG & MORI, P.C., 10507 BRADDOCK ROAD, SUITE A, FAIRFAX, VA, 22032, US

(73) Assignee: HONDA MOTOR CO., LTD., Tokyo (JP)

(21) Appl. No.: 11/478,197

(22) Filed: Jun. 29, 2006

(30) Foreign Application Priority Data
Jun. 29, 2005 (JP) 2005-190725

(51) Int. Cl. B60L 1/00

(52) U.S. Cl. 307/9.1

(57) ABSTRACT

An image sending apparatus includes an imaging device configured to capture images of a vehicle, an image recording device configured to record a plurality of image data of the images captured by the imaging device, a priority setting device configured to give a sending priority to the plurality of image data, and an image sending device configured to send the image data to an outside of the vehicle in an order according to the sending priority when a predetermined emergency condition occurs.

### BACKGROUND OF THE INVENTION

Priority is claimed on Japanese Patent Application No. 2005-190725, filed Jun. 29, 2005, the contents of which are incorporated herein by reference.

1. Field of the Invention

This invention relates to an image sending apparatus and an image sending method.

2. Description of the Related Art

In an example of a known emergency informing device, when an abnormality of a vehicle resulting from an accident or the like is detected, an imaging direction of a camera installed in the vehicle is switched towards occupants, and an image of the occupants is sent to a remote emergency center with information about the position of the vehicle detected by a position detection apparatus (for example Japanese Unexamined Patent Application, First Publication No. 2003-306106).

Furthermore, in an example of a known image data recording device, where a plurality of cameras are installed in the vehicle, the images captured by the in-vehicle camera that faces the direction in which impact force is applied at the time of a collision is recorded (for example Japanese Unexamined Patent Application, First Publication No. 07-304473).

Incidentally, according to the emergency informing device exemplified in the related art, an image taken by an in-vehicle camera is simply sent to a remote emergency center, and all that occurs is a plurality of images that form a time series are sent in the order in which they were taken. However, because the degree of correspondence between the importance of an image and the time when it was taken varies according to the abnormal condition that affected the vehicle or the occupants, if a plurality of images are simply sent in order of the time when they were taken, images of relatively greater importance may be sent after images or relatively less importance. In this case, if the abnormal condition requires an urgent response, the appropriate response may not be achievable in a timely manner. Moreover, when the sending of multiple images increases communication traffic to the extent that network congestion or the like causes the communication properties to deteriorate before the images of relatively greater importance can be sent, the images of relatively greater importance may be further delayed. As a result, the length of time before the nature of the abnormal condition affecting the vehicle or occupants is correctly ascertained from the images sent from the vehicle may be excessive.

Furthermore, even if the emergency informing apparatus exemplified in the related art is used in combination with the image data recording apparatus exemplified in the related art, the plurality of images taken by the in-vehicle camera facing the direction of the impact force during the collision are simply sent to a remote emergency center in the order in which they were taken. Accordingly, for example if images containing important information are present nearer the end in the time series, the appropriate response to the abnormal condition may not be achievable in a timely manner.

### SUMMARY OF THE INVENTION

According to one aspect of the present invention, an image sending apparatus includes an imaging device configured to capture images of a vehicle, an image recording device configured to record a plurality of image data of the images captured by the imaging device, a priority setting device, and an image sending device. The priority setting device is configured to give a sending priority to the plurality of image data. The image sending device is configured to send the image data to an outside of the vehicle in an order according to the sending priority when a predetermined emergency condition occurs.

According to another aspect of the present invention, an image sending method includes capturing images of a vehicle, recording a plurality of image data of the captured images, giving a sending priority to the plurality of image data, and sending the image data to an outside of the vehicle in an order according to the sending priority when a predetermined emergency condition occurs.

### BRIEF DESCRIPTION OF THE DRAWINGS

FIG. 1 is a diagram showing the construction of an image sending apparatus according to an embodiment of the present invention.

FIG. 2 is a diagram showing an example of priority levels respectively set for a plurality of image frames in a time series.

FIG. 3 is a graph showing an example of how the amount of information varies according to the length of time elapsed since transmission began, for cases where priority transmission is and is not performed, the horizontal axis showing time elapsed, and the vertical axis showing the amount of information.

FIG. 4 is a diagram showing an example of the priority levels set for image information corresponding to spatial regions PF1 to PF4 set in each image frame.

FIG. 5 is a diagram showing an example of predetermined spatial regions A1 and A2 established within an image frame PF captured by a camera facing from the front of the cabin to the rear.

FIG. 6 is a diagram showing an example of a spatial region A3 set within the image frame PF showing the region outside the subject vehicle containing the direction of action of acceleration.

FIG. 7 shows an example of the priority levels set for respective predetermined partial regions PA1 to PA8 within a three-dimensional time-space composed of a time axis t based on the capture time, and a two dimensional spatial axis x, y related to the image plane of the image frame.

FIG. 8 shows an example of the priority levels set for respective predetermined partial regions PA1 to PA7 within a three-dimensional time-space composed of a time axis t related to the capture time, and a two dimensional spatial axis x, y related to the image plane of the image frame.

### DETAILED DESCRIPTION OF THE INVENTION

An embodiment of the image sending apparatus of the present invention is described below with reference to the appended drawings.

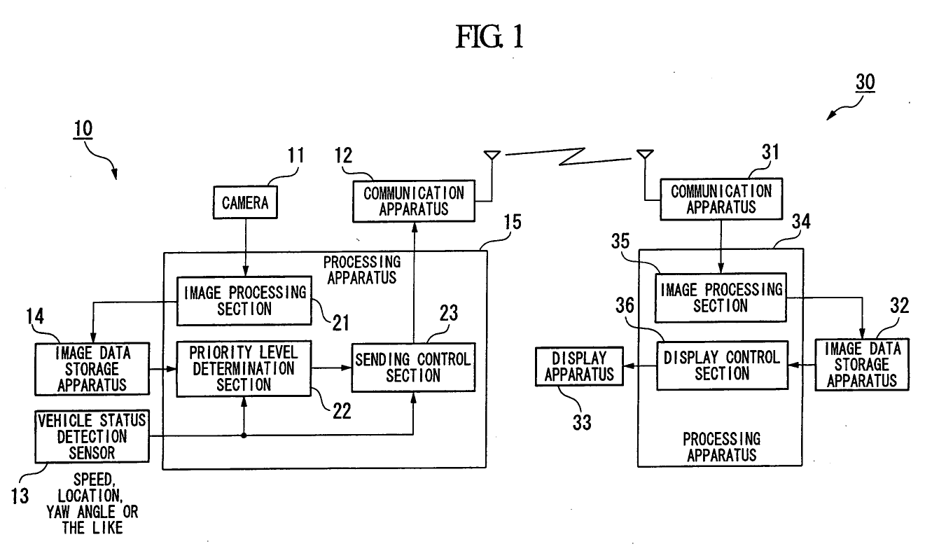

As shown in FIG. 1, an image sending apparatus 10 of the present embodiment includes; a camera 11 which captures at least the interior or exterior of a subject vehicle, a communication apparatus 12, a vehicle status detection sensor 13, an image data storage apparatus 14, and a processing apparatus 15.

An example of the camera 11 is a CCD (Charge-Coupled Device) camera or CMOS (Complementary Metal Oxide Semiconductor) camera capable of capturing images in the visible light region. The camera 11, which is mounted to the roof inside the vehicle and has a horizontal field of view of 360°, outputs captured images of the vehicle interior and occupants as well as images of the external environment around the vehicle captured through the vehicle windows.

The communication apparatus 12 sends the image data output from the processing apparatus 15 by communicating with a remote emergency reporting center 30.

The vehicle status detection sensor 13 acquires vehicle information about a subject vehicle, and may include for example, (i) a vehicle speed sensor which detects the speed of the subject vehicle, (ii) a position sensor which detects the current location and direction of travel of the subject vehicle based on a positioning signal such as a GPS (Global Positioning System) signal which determines the position of the subject vehicle (for example, latitude and longitude) using an artificial satellite, or a location signal transmitted from an information transmission apparatus remote to the subject vehicle, as well as the results of a gyrosensor or acceleration sensor as appropriate, (iii) a yaw rate sensor which detects the yaw angle (the angle of rotation about a vertical axis in relation to the center of gravity of the vehicle) and yaw rate (the speed of rotation about a vertical axis in relation to the vehicle center of gravity), (iv) a steering angle sensor which detects the steering angle (the direction and magnitude of steering input by the driver) and the actual turning angle (wheel angle) corresponding to the steering angle, or (v) a seating sensor or weight sensor which detects whether an occupant is present.

The image data storage apparatus 14 includes a computer-readable storage medium such as a magnetic disk drive or optical disk drive, and stores as time series data the image data (image frames) output from the processing apparatus 15 based on images captured at predetermined intervals by the camera 11.

The processing apparatus 15 includes, for example, an image processing section 21, a priority level determination section 22, and a sending control section 23.

The image processing section 21, for example, performs predetermined image processing on the images taken by the camera 11, such as projective transformation, filtering, or binarization, and generates image data (image frames) composed of a two-dimensional array of pixels, and outputs the image data to the image data storage apparatus 14.

The priority level determination section 22 performs, for example, processing based on time-based priority. In this processing, the priority level determination section 22 also sets, for each of the plurality of pieces of image data (image frames) which make up the time series data stored in the image data storage apparatus 14, a priority for transmission to the emergency reporting center 30 remote to the subject vehicle.

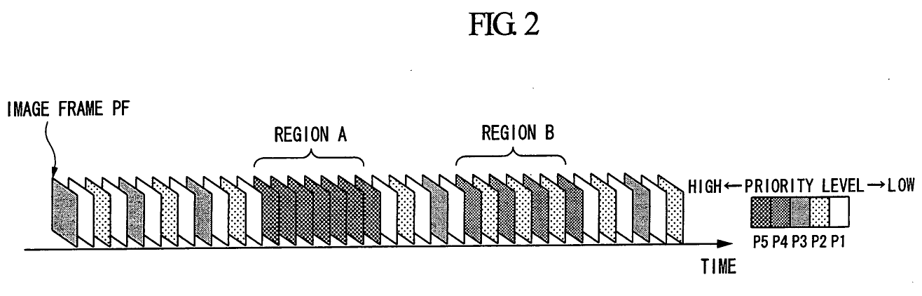

As shown in FIG. 2, the priority level determination section 22 sets one of a plurality of (for example five) priority levels P1 to P5 (where P1<P2<P3<P4<P5). As described below, the priority levels P1 to P5 are set for each of the image frames PF based on the results of such determination as to; whether or not the image frame corresponds to a predetermined time period set in advance, whether or not the image frame corresponds to a time period in which the variation in a predetermined evaluation function exceeds a predetermined value, or whether or not the image frame corresponds to a time period in which the variation in the appropriate detection result of the vehicle status detection sensor 13 exceeds a predetermined value.

The sending control section 23 sets the order and frame rate to use when sending each image frame from the communication apparatus 12 to the emergency reporting center 30 according to the priority level set for each piece of image data (image frame) by the priority level determination section 22.

For example, as shown in FIG. 2, when the priority level determination section 22 has set a priority level P1 to P5 for each of the plurality of image frames PF, in the form of time series data captured by the camera 11 and stored in the image data storage apparatus 14, the sending control section 23 first sets the order of transmission for each of a plurality of time periods composed of an appropriate group of image frames PF. For example, as shown in FIG. 2, the region A composed of image frames PF which have the highest priority level P5 are placed first in the transmission order. Furthermore, the region B composed of image frames PF which have the next highest priority levels P4 and P3 is placed second in the transmission order.

Next, the sending control section 23 sets the frame rate for transmission for each of the plurality of time periods assigned a transmission order. For example, as shown in FIG. 2, the highest frame rate is set for region A which was placed first in the transmission order. Furthermore, for region B which was placed second in the transmission order, a lower frame rate is set than that set for region A.

The sending control section 23 can also set the frame rate to zero. This enables the transmission of image frames whose priority level is less than a predetermined value to be prevented.

Then, based on the detection results of the vehicle status detection sensor 13, the sending control section 23 uses the communication apparatus 12 to transmit the plurality of image frames PF, extracted from the image data storage apparatus 14 via the priority level determination section 22, to the emergency reporting center 30 in accordance with the assigned transmission order and frame rate.

As shown in FIG. 1, the emergency reporting center 30 which receives the image data sent from the subject vehicle includes; a communication apparatus 31, an image data storage apparatus 32, a display apparatus 33, and a processing apparatus 34. The processing apparatus 34 performs predetermined image processing of image data received via the communication apparatus 31, and includes an image processing section 35 which stores the processed image data in the image data storage apparatus 32, and a display control section 36 which displays the image data stored in the image data storage apparatus 32 on the display apparatus 33.

The image sending apparatus 10 of the present embodiment has the construction described above. Next, the operation of this image sending apparatus 10 is described.

The operation of the priority level determination section 22 and the sending control section 23 is described below, particularly the processing which sets the priority levels P1 to P5 for each image frame PF based on time-based priority, and the processing which sets the frame rate for transmission.

First, in a case where the priority level determination section 22 sets the priority levels P1 to P5 based on the result of a determination as to whether or not the image frame corresponds to a predetermined time period specified in advance, and for example the time at which a collision is detected is deemed the base time (collision time), the priority level determination section 22 sets priority levels for the image frames in the time periods on each side of the collision time, such that the priority level increases with increasing proximity to the collision time.

Relatively crucial information, such as the collision target, the relative speed of the collision target, and the behavior of the subject vehicle after the collision, is detected in the predetermined time period on each side of the collision time (for example, a time period including one second on each side of the collision time or including several seconds on each side the collision time) from the images of the subject vehicle surroundings captured through the windows of the subject vehicle by the camera 11. Furthermore, from the images of the vehicle interior and occupants captured by the camera 11, relatively crucial information about the status of the occupants immediately prior to the collision (for example, whether or not an occupant suffered a seizure or adopted a defensive stance) is detected, including whether or not contact occurred between an occupant and the vehicle interior, whether or not the airbags have been deployed, and the status of the occupants immediately after the collision (for example, whether or not injury or bleeding is present). For this reason, the highest priority level P5 is set for image frames corresponding to the time period including one second (or several seconds) on each side of the collision time.

In this case, the sending control section 23 places the time period one second each side of the collision time, for which the highest priority level P5 is set, first in the transmission order, and sets the highest predetermined frame rate (for example 30 frames per second). The sending control section 23 then places the time period one to ten seconds after the collision time (that is the time period containing information related to the status after the collision) second in the transmission order, and sets a predetermined frame rate (for example, 5 frames per second). Furthermore, the sending control section 23 then places the time period preceding the collision time by one to five seconds (that is the time period containing information related to the status leading up to the collision) third in the transmission order, and sets a predetermined frame rate (for example, 5 frames per second).

First, the plurality of image frames that form the time period placed first in the transmission order are sent in the order in which they were captured by the camera 11. Then, the plurality of image frames that form the time period placed second in the transmission order are sent in the order in which they were captured by the camera 11. Next, the plurality of image frames that form the time period placed third in the transmission order are sent in the order in which they were captured by the camera 11.

In a case where the priority level determination section 22 sets the priority levels P1 to P5 based on the result of a determination as to whether or not the image frame corresponds to a predetermined time period set in advance, and for example the time at which a predetermined operation by an occupant of the subject vehicle is detected (for example, turning a particular switch ON) is deemed the base time (operation time), the priority level determination section 22 sets priority levels for the image frames in the time period leading up to the operation time such that the priority level increases with increasing proximity to the operation time.

In the time period of several seconds (for example, three seconds) which is the predetermined time period leading up to the operation time, relatively crucial information about the state of consciousness of the occupants as well as the presence and severity of injuries is detected based on the actions and countenance of the occupants shown in the images of the occupants taken by the camera 11. Therefore, the highest priority level P5 is set for the image frames corresponding to the time period of several seconds (for example, three seconds) leading up to the operation time.

Furthermore, in a case where the priority level determination section 22 sets the priority levels P1 to P5 based on the result of a determination as to whether or not the image frame corresponds to a time period in which the variation in a predetermined evaluation function exceeds a predetermined value, and the sum of the squares of the difference in luminance, within an entire area in the image frame, between pixels in adjacent image frames in the time series is used as the evaluation function f (t), the priority level determination section 22 sets priority levels in an increasing trend as the value of the evaluation function f (t) increases.

In other words, the priority level determination section 22 determines that an increase in the value of the evaluation function f (t) means an increase in the variation in the image frames, and a higher likelihood that the image frames contain information about the relative movement of the object that collided with the subject vehicle and the actions of the occupants, and increases the priority level accordingly.

The evaluation function f (t) is a function of the time axis t which represents the time at which the camera 11 captured the image.

Furthermore, in a case where the priority level determination section 22 sets the priority levels P1 to P5 based on the result of a determination as to whether or not the image frame corresponds to a time period in which the variation in a detection result of the vehicle status detection sensor 13 exceeds a predetermined value, the priority levels may be set in an increasing trend with increasing variation in the acceleration (or deceleration) or yaw rate of the subject vehicle, as detected by the vehicle status detection sensor 13.

In other words, the priority level determination section 22 determines that as the variation in the acceleration (or deceleration) or yaw rate of the subject vehicle increases, there is a higher likelihood that the image frame contains information about the relative movement of the object that collided with the subject vehicle, and about the reaction of the occupants inside the vehicle to the change in the movement status of the subject vehicle, and increases the priority level accordingly.

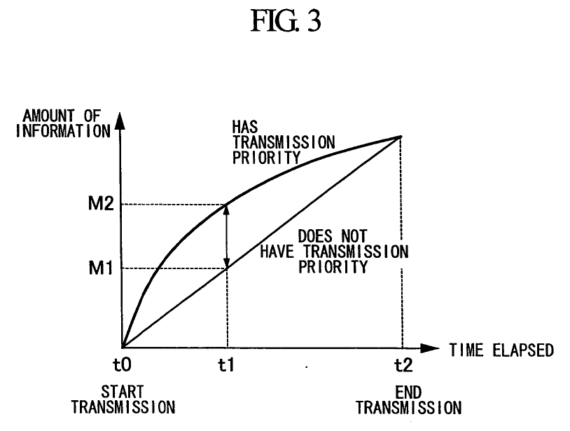

According to the image sending apparatus 10 as described above, in the case of an emergency such as a collision, image frames with a relatively high priority level are sent to the emergency reporting center 30 preferentially over image frames with a relatively low priority level. Moreover, the frame rate used to send the image frames with a relatively high priority level is set to a higher value than the frame rate used to send the image frames with a relatively low priority level. Thus, in particular, image frames with a relatively high priority are sent at a relatively high frame rate within a comparatively short time after transmission begins (that is, after the emergency situation develops). As a result, as shown in FIG. 3 for example, the present embodiment (priority-based transmission) enables an increased amount of information (increased from an amount of information M1 to an amount of information M2, for example) to be sent to the remote location within a comparatively short time (time t0 to time t1) after transmission begins (at time t0), as compared to a case in which a plurality of image frames are sent in the order in which they were captured by the camera 11 (no priority transmission). As a result, when an emergency requiring a fast response occurs, the appropriate response can be achieved in a timely manner.

In the present embodiment the priority level determination section 22 sets priority levels by using processing based on time-based priority. However, the present invention is not limited to this configuration, and priority levels may be set by using processing based on spatial priority.

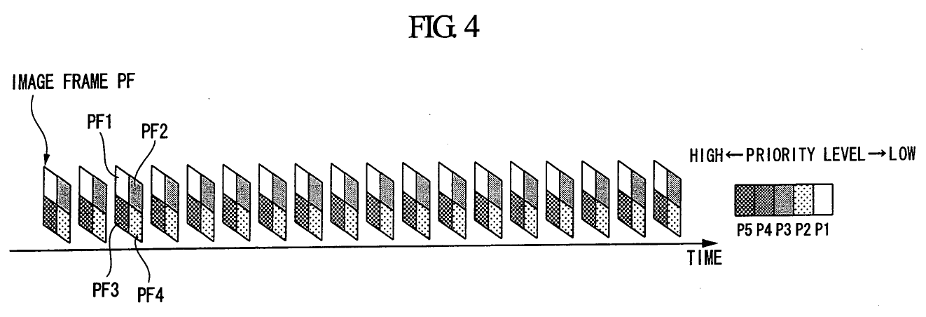

In this case, priority levels P1 to P5 (where P1<P2<P3<P4<P5) are set for image information corresponding to spatial regions PF1 to PF4 established within each image frame PF as shown in FIG. 4, based on the result of such determinations as to; whether or not the image information in the image frame to be set with a priority level corresponds to a predetermined spatial region set in the image frame in advance, whether or not the image information in the image frame to be set with a priority level corresponds to a spatial region within the image frame in which the variation in a predetermined evaluation function exceeds a predetermined value, or whether or not the image information in the image frame to be set with a priority level corresponds to a predetermined spatial region within the image frame related to a detection result of the vehicle status detection sensor 13.

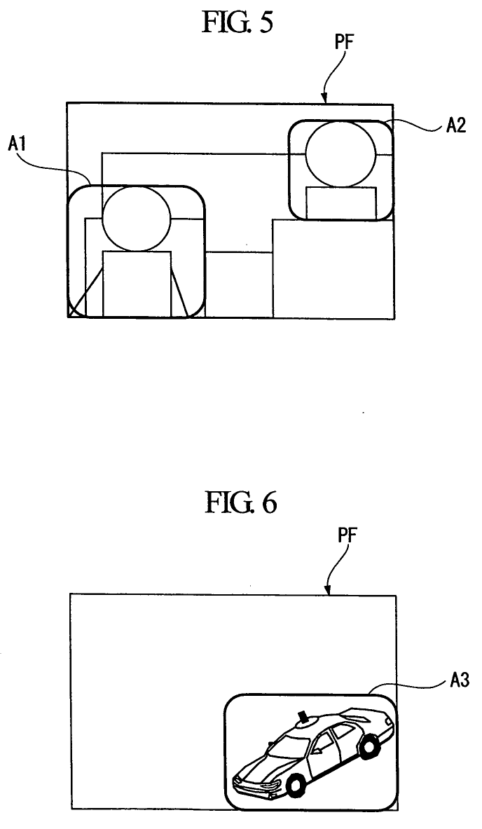

First, in a case where the priority level determination section 22 sets priority levels based on the result of a determination as to whether or not the image information corresponds to predetermined spatial regions set within the image frame in advance, and the predetermined spatial regions are set in an image frame PF captured by the camera 11 showing the vehicle interior from the front towards the back as shown in FIG. 5, the priority level determination section 22 sets a higher priority level to the pieces of image information which correspond to the spatial region A1 in which the driver of the subject vehicle is pictured and the spatial region A2 in which another occupant is pictured, than for image information corresponding to other spatial regions within the image frame PF.

Furthermore, in a case where the priority level determination section 22 sets priority levels based on the result of a determination as to whether or not the image information corresponds to a spatial region within the image frame in which the variation in a predetermined evaluation function exceeds a predetermined value, and the distribution on the image plane of the square of the difference in luminance between pixels in adjacent image frames in the time series is used as the evaluation function f (x, y), the priority level determination section 22 sets a higher priority level for image information corresponding to a spatial region within the image frame where the value of the evaluation function f (x, y) increases, than for image information corresponding to other spatial regions within the image frame.

In other words, the priority level determination section 22 determines that spatial regions in which the value of the evaluation function f (x, y) increases are more likely to contain the occupants of the subject vehicle and the object with which the subject vehicle collided, for example, and increases the priority level accordingly.

The evaluation function f (x, y) is a function based on a two-dimensional spatial axis x, y on the image plane of the image frame PF.

Furthermore, in a case where the priority level determination section 22 sets priority levels according to the result of a determination as to whether or not the image information in the image frame to be set with a priority level corresponds to a predetermined spatial region within the image frame related to a detection result of the vehicle status detection sensor 13, and for example the presence or absence of an occupant is detected based on whether or not a seating sensor or weight sensor serving as the vehicle status detection sensor 13 detects an occupant, the priority level determination section 22 sets a higher priority level for image information corresponding to spatial regions which contain a seat inside the vehicle, than for image information corresponding to other spatial regions in the image frame.

The method of detecting occupants is not limited to the results of the vehicle status detection sensor 13, and for example occupants may be detected based on the recognition result of image recognition processing performed on the captured images by the image processing section 21.

In a case where the priority level determination section 22 sets priority levels according to the result of a determination as to whether or not the image information corresponds to a predetermined spatial region within the image frame related to a detection result of the vehicle status detection sensor 13, and for example an acceleration sensor serving as the vehicle status detection sensor 13 detects the degree and direction of action of acceleration (or deceleration) of the subject vehicle, the priority level determination section 22 sets a higher priority level for image information corresponding to the spatial regions outside and inside the subject vehicle which contain this direction of action, than for image information corresponding to other spatial regions within the image frame.

In other words, as shown in FIG. 6, the priority level determination section 22 determines that the spatial region A3, which is outside the subject vehicle and contains the direction of action of the acceleration, and the spatial regions inside the vehicle, are more likely to contain the object that will collide with the subject vehicle, or the occupants or the like who are exposed to a secondary collision inside the subject vehicle, and increases the priority level accordingly.

In the present embodiment, the priority level determination section 22 sets priority levels by performing time-based processing. However, the present invention is not limited to this configuration, and priority levels may be set by performing processing based on both time and space, that is, a combination of time-based priority and spatial priority, for example.

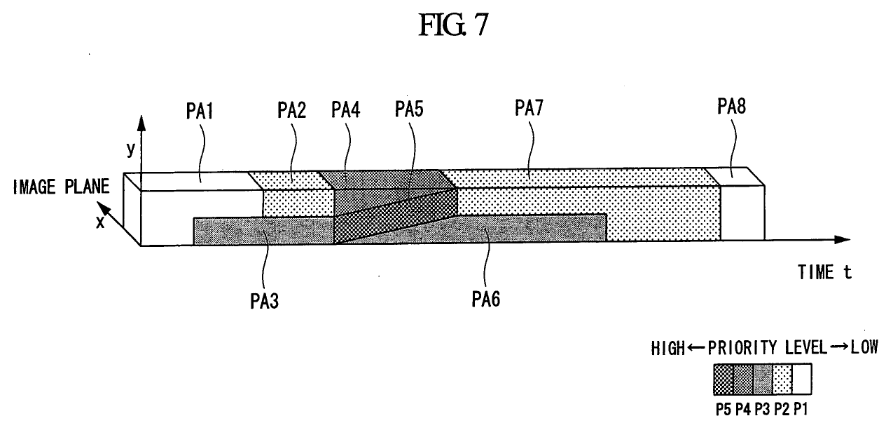

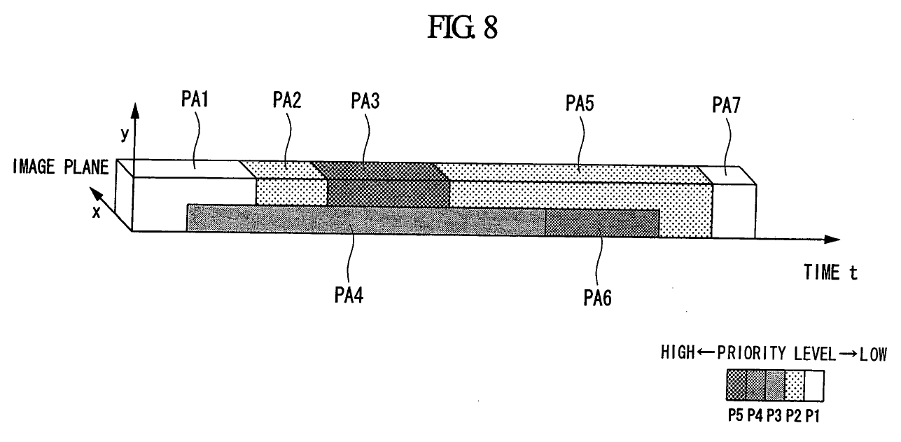

In this case, as shown in FIG. 7 and FIG. 8, a three-dimensional time-space is established for the plurality of image frames which are arranged in the order in which they were captured by the camera 11 to form the time series data, based on a time axis t corresponding to the capture time, and a two-dimensional spatial axis x, y corresponding to the image plane of the image frame PF. Then, for example as shown in FIG. 7 and FIG. 8, priority levels P1 to P5 (where P1<P2<P3<P4<P5) are set for the image information corresponding to the plurality of partial regions PA1 to PA8 within the three-dimensional time-space according to the result of such determinations as to; whether or not the image information of the partial region to be set with a priority level corresponds to a predetermined partial region set within the three-dimensional time-space in advance, whether or not the image information of the partial region to be set with a priority level corresponds to a partial region within the three-dimensional time-space in which the variation in a predetermined evaluation function exceeds a predetermined value, or whether or not the image information of the partial region to be set with a priority level corresponds to a predetermined partial region within the three-dimensional time-space related to a detection result of the vehicle status detection sensor 13.

First, in a case where the priority level determination section 22 sets priority levels based on the result of a determination as to whether or not the image information of the partial region to be set with a priority level corresponds to a predetermined partial region set within the three-dimensional time-space in advance, and the predetermined partial region is set within the three-dimensional time-space based on; a predetermined time period either side of the collision time (for example, a time period from the collision time until 0.5 seconds after the collision time) deeming the time at which a collision or the like was detected the base time (the collision time), and a region within the image frame of the vehicle interior captured by the camera 11 which pictures the deployment of the airbag, the priority level determination section 22 sets a higher priority level for image information corresponding to this partial region than for image information corresponding to other partial regions within the three-dimensional time-space.

Furthermore, in a case where the priority level determination section 22 sets priority levels based on the result of a determination as to whether or not the image information of the partial region to be set with a priority level corresponds to a partial region within three-dimensional time-space in which the variation in a predetermined evaluation function exceeds a predetermined value, and for example the distribution within three-dimensional time-space obtained by further extrapolating the distribution on the image plane of the square of the difference in luminance between pixels in adjacent image frames in the time series, over a combination of a plurality of adjoining image frames, is used as the evaluation function f (x, y, t), the priority level determination section 22 sets higher priority levels for image information from partial regions with a higher value for the evaluation function f (x, y, t), within the three-dimensional time-space, than for image information corresponding to other partial regions within the image frame.

In other words, the priority level determination section 22 determines that partial regions in which the value of the evaluation function f (x, y, t) is high are more likely to contain the object with which the vehicle collided or occupants or the like, and increases the priority level accordingly.

The evaluation function f (x, y, t) is a function of the two-dimensional spatial axis x, y corresponding to the image plane of the image frame, and the time axis t corresponding to the capture time.

Furthermore, in a case where the priority level determination section 22 sets priority levels based on the result of a determination as to whether or not the image information of the partial region to be set with a priority level corresponds to a predetermined partial region within the three-dimensional time-space related to the appropriate detection results of the vehicle status detection sensor 13, and for example the presence or absence of an occupant is detected by using a seating sensor or weight sensor as the vehicle status detection sensor 13, the priority level determination section 22 sets a higher priority level for image information corresponding to a predetermined partial region within the three-dimensional time-space, set based on the spatial region containing the seats inside the vehicle and, a predetermined time period each side of the collision time (for example, 1 second each side of the collision time) deeming the time at which a collision or the like was detected the base time (the collision time), than for image information corresponding to other partial regions within the three-dimensional time-space.

Detection of the presence or absence of an occupant need not be based on the detection results of the vehicle status detection sensor 13, and may be performed based on the recognition results of image recognition processing performed on the captured images by the image processing section 21.

Furthermore, in a case where the priority level determination section 22 sets priority levels based on the result of a determination as to whether or not the image information of the partial region to be set with a priority level corresponds to a predetermined partial region within the three-dimensional time-space related to a detection result of the vehicle status detection sensor 13, and for example the magnitude and direction of action of the acceleration (or deceleration) of the subject vehicle is detected by an acceleration sensor serving as the vehicle status detection sensor 13, the priority level determination section 22 sets a higher priority level for image information corresponding to a predetermined partial region within the three-dimensional time-space, set based on the spatial regions outside and inside the subject vehicle which contain this direction of action, and a predetermined time period each side of a base time (for example, 1 second each side of collision time) deeming the time at which acceleration (or deceleration) is maximum the base time, than for image information corresponding to other partial regions within the three-dimensional time-space.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image sending apparatus comprising:
an imaging device configured to capture images of a vehicle;
an image recording device configured to record a plurality of image data of the images captured by the imaging device;
a priority setting device configured to give a sending priority to the plurality of image data; and
an image sending device configured to send said image data to an outside of the vehicle in an order according to the sending priority when a predetermined emergency condition occurs.

2. The image sending apparatus according to claim 1, wherein
said image sending device includes a frame rate conversion device which is configured to increase a frame rate for sending said image data as said sending priority is higher.

3. The image sending apparatus according to claim 1, wherein
said image sending device is configured to send only said image data whose sending priority is higher than a predetermined level.

4. The image sending apparatus according to claim 1, wherein
said priority setting device is configured to give said sending priority based on a time-based priority.

5. The image sending apparatus according to claim 4, wherein said priority setting device is configured to give said sending priority based on a result of a determination as to whether or not said image data corresponds to a previously set predetermined time period.

6. The image sending apparatus according to claim 4, wherein
said priority setting device is configured to give said sending priority based on a result of a determination as to whether or not said image data corresponds to a time period in which a variation of a predetermined evaluation function exceeds a predetermined value.

7. The image sending apparatus according to claim 4, further comprising a vehicle status detection sensor which is configured to detect a status of at least said vehicle, wherein
said priority setting device is configured to give said sending priority based on a result of a determination as to whether or not said image data corresponds to a time period in which a variation in a detection value of said vehicle status detection sensor exceeds a predetermined value.

8. The image sending apparatus according to claim 1, wherein
said priority setting device is configured to give said sending priority based on a spatial priority.

9. The image sending apparatus according to claim 8, wherein
said priority setting device is configured to give said sending priority based on a result of a determination as to whether or not said image data corresponds to a predetermined spatial region set in advance within an image frame.

10. The image sending apparatus according to claim 8, wherein
said priority setting device is configured to give said sending priority based on a result of a determination as to whether or not said image data corresponds to a time period in which a variation of a predetermined evaluation function exceeds a predetermined value.

11. The image sending apparatus according to claim 8, further comprising a vehicle status detection sensor which is configured to detect a status of at least said vehicle, wherein
said priority setting device is configured to give said sending priority based on a result of a determination as to whether or not said image data corresponds to a predetermined spatial region related to a detection result of said vehicle status detection sensor.

12. The image sending apparatus according to claim 1, wherein
said priority setting device is configured to give said sending priority based on a combination of a time-based priority and a spatial priority.

13. The image sending apparatus according to claim 12, wherein
said priority setting device is configured to give said sending priority based on a result of a determination as to whether or not said image data corresponds to image information of a predetermined partial region within a previously set three-dimensional time-space composed of a time axis and a planar spatial axis.

14. The image sending apparatus according to claim 12, wherein
said the priority setting device is configured to give said sending priority based on a result of a determination as to whether or not image information of a predetermined partial region within a previously set three-dimensional time-space composed of a time axis and a planar spatial axis is image information of a partial region corresponding to a partial region in which a variation in a predetermined evaluation function exceeds a predetermined value.

15. The image sending apparatus according to claim 12, further comprising a vehicle status detection sensor which detects a status of at least said subject vehicle, wherein
said priority setting device is configured to give said sending priority based on a result of a determination as to whether or not said image data corresponds to image information of a predetermined partial region within three-dimensional time-space related to a detection result of said vehicle status detection sensor.

16. The image sending apparatus according to claim 1, wherein said imaging device is configured to capture images of an inside or outside of the vehicle.

17. An image sending apparatus comprising:
imaging means for capturing images of a vehicle;
image recording means for recording a plurality of image data of the images captured by the imaging means;
priority setting means for giving a sending priority to the plurality of image data; and
image sending means for sending said image data to an outside of the vehicle in an order according to the sending priority when a predetermined emergency condition occurs.

18. An image sending method comprising:
capturing images of a vehicle;
recording a plurality of image data of the captured images;
giving a sending priority to the plurality of image data; and
sending said image data to an outside of the vehicle in an order according to the sending priority when a predetermined emergency condition occurs.
